(19) United States
(12) Patent Application Publication
(10) Pub. No.: US 2024/0408600 A1
(43) Pub. Date: Dec. 12, 2024

(54) MICROFLUIDIC DEVICE

(71) Applicant: Panasonic Intellectual Property Management Co., Ltd., Osaka (JP)

(72) Inventors: TAICHI NAKAMURA, Osaka (JP); HIROAKI YOSHIDA, Osaka (JP); TOSHIFUMI NAGINO, Osaka (JP)

(21) Appl. No.: 18/810,576

(22) Filed: Aug. 21, 2024

Related U.S. Application Data
(63) Continuation of application No. PCT/JP2022/035259, filed on Sep. 21, 2022.

(30) Foreign Application Priority Data
Mar. 2, 2022 (JP) 2022-032027

(51) Int. Cl. B01L 3/00; B01F 23/45; B01F 31/80; B01F 33/301; B01F 101/00

(52) U.S. Cl. CPC B01L 3/502761; B01F 23/45; B01F 31/841; B01F 33/3017; B01F 2101/2204; B01L 2200/0652; B01L 2300/0867; B01L 2300/18; B01L 2400/0433

(57) ABSTRACT

A microfluidic device comprises: a first channel through which a first raw material fluid flows; a second channel through which a second raw material fluid flows; a synthesis channel portion that joins the first channel and the second channel to cause the first raw material fluid and the second raw material fluid to react with each other to generate nuclei, thereby obtaining a fluid containing particles obtained by growing the nuclei; and a vibration applicator that applies vibration to the fluid flowing through the synthesis channel portion, in which the synthesis channel portion includes a mixing channel portion that is a merging portion of the first channel and the second channel, a stagnation channel portion that communicates with a downstream side of the mixing channel portion and to which vibration is applied by the vibration applicator.

### TECHNICAL FIELD

The present disclosure relates to a microfluidic device that chemically reacts a plurality of fluids in a channel to produce a compound, such as particles.

### BACKGROUND ART

In recent years, efforts have been actively made to apply a so-called microreactor, which is a device for mixing fluids in a channel manufactured by a micromachining technology or the like, to the biotechnology and medical fields and the like. Characteristics of the microreactor include: (1) temperature control can be accurately and efficiently performed; (2) uniform mixing can be performed under a laminar flow; and (3) mixing proceeds rapidly because of a short diffusion length of a substance.

In recent years, the trend of applying a microreactor to a particle synthesis process on the order of nanometers by a liquid phase synthesis method leveraging these characteristics has been accelerated.

In the case of synthesizing uniform particles, if the timing of nucleation or the particle growth time varies, the particle diameter varies. Therefore, it is necessary to control the processes of nucleation, particle growth, and aggregation. In a conventional batch method in which fluids are mixed by mechanical stirring, it is difficult to stably produce particles having a uniform particle diameter in a certain amount due to variations in synthesis conditions such as uneven concentration and uneven temperature.

Therefore, by applying the microreactor, it is possible to continuously synthesize monodisperse particles having a uniform particle diameter since the microreactor is quickly and uniformly mixed at the phase of nucleation under the condition of precise temperature control and the time is kept constant at the phase of particle growth.

However, when particles are generated in the microchannel, the particles are bonded and deposited in the channel due to deposition or aggregation of the particles, and the channel is eventually blocked. Therefore, it is difficult to continuously use for a long time.

Therefore, in order to solve these problems, there is disclosed a method capable of stably producing particles having a uniform particle diameter by synthesis using a device including a mixing channel portion that mixes a plurality of fluids, a stagnation channel portion that is connected in series to the mixing channel portion and in which particles produced in the mixing channel portion are retained, a detection mechanism that detects a value of pressure in the stagnation channel portion, and a vibration applying mechanism that applies vibration only to the stagnation channel portion on the basis of a value detected by the detection mechanism (see, for example, PTL 1).

### CITATION LIST

### Patent Literature

PTL 1: Japanese Patent No. 5081845

### SUMMARY OF THE INVENTION

A microfluidic device according to the present disclosure includes: a first channel through which a first raw material fluid flows; a second channel through which a second raw material fluid flows; a synthesis channel portion that joins the first channel and the second channel to cause the first raw material fluid and the second raw material fluid to react with each other to generate nuclei, thereby obtaining a fluid containing particles obtained by growing the nuclei; and a vibration applicator that applies vibration to the fluid flowing through the synthesis channel portion, in which the synthesis channel portion includes a mixing channel portion that is a merging portion of the first channel and the second channel, a stagnation channel portion that communicates with a downstream side of the mixing channel portion and to which vibration is applied by the vibration applicator.

### BRIEF DESCRIPTION OF THE DRAWINGS

FIG. 1 is a schematic view illustrating a configuration of a synthesis device according to the present exemplary embodiment.

FIG. 2 is an exploded perspective view illustrating a configuration of a microfluidic device according to the present exemplary embodiment used in the synthesizer of FIG. 1.

FIG. 3 is a partial cross-sectional view illustrating a cross-sectional structure of a synthesis channel portion of the microfluidic device according to the present exemplary embodiment.

FIG. 4 is a diagram illustrating synthesis times, synthesis results, and determinations of Example 1 and Comparative Example 1.

### DESCRIPTION OF EMBODIMENT

In the synthesis method using the device described in PTL 1, since vibration is applied only to the stagnation channel portion separated in the downstream direction with respect to the mixing channel portion, the synthesis method can be applied to a material whose time from the nucleation phase to the growth phase is sufficiently long in the particle formation process, but cannot be applied to a material whose time from the nucleation phase to the growth phase is short.

The present disclosure has been made in view of the above, and an object of the present disclosure is to provide a microchannel device that stably produces particles having a uniform particle diameter even with a material whose time from nucleation to a growth phase in a particle formation process is short.

A microfluidic device according to a first aspect includes: a first channel through which a first raw material fluid flows; a second channel through which a second raw material fluid flows; a synthesis channel portion that joins the first channel and the second channel to cause the first raw material fluid and the second raw material fluid to react with each other to generate nuclei, thereby obtaining a fluid containing particles obtained by growing the nuclei; and a vibration applicator that applies vibration to the fluid flowing through the synthesis channel portion, in which the synthesis channel portion includes a mixing channel portion that is a merging portion of the first channel and the second channel, a stagnation channel portion that communicates with a downstream side of the mixing channel portion and to which vibration is applied by the vibration applicator.

In a microfluidic device according to a second aspect, in the first aspect, a fluid cross-sectional area of at least a part of the stagnation channel portion perpendicular to a flow direction of the fluid may be larger than a fluid cross-sectional area of the mixing channel portion perpendicular to the flow direction of the fluid.

In a microfluidic device according to a third aspect, in the second aspect, the at least a part of the stagnation channel portion is a stagnation channel first portion on an upstream side, and the stagnation channel portion may further include a stagnation channel second portion that is on a downstream side of the stagnation channel first portion and has a fluid cross-sectional area perpendicular to the flow direction of the fluid smaller than the fluid cross-sectional area perpendicular to the flow direction of the fluid in the stagnation channel first portion.

In a microfluidic device according to a fourth aspect, in the second or third aspect, a length of the at least a part of the stagnation channel portion along a vibration direction applied from the vibration applicator may be longer than a length of the mixing channel portion along the vibration direction.

In a microfluidic device according to a fifth aspect, in any one of the second to fourth aspect, the vibration applicator applies vibration to the stagnation channel portion from above in a vertical direction, and a channel depth of the at least a part of the stagnation channel portion in the vertical direction may be greater than a channel depth of the mixing channel portion in the vertical direction.

A synthesis device according to a sixth aspect includes the microfluidic device according to any one of the first to fifth aspects as a synthesizer.

Hereinafter, a microfluidic device, and a synthesis device employing the microfluidic device according to exemplary embodiments will be described with reference to the accompanying drawings. The drawings show substantially the same members that are designated by the same reference numerals.

### Exemplary Embodiments

### <Synthesis Device>

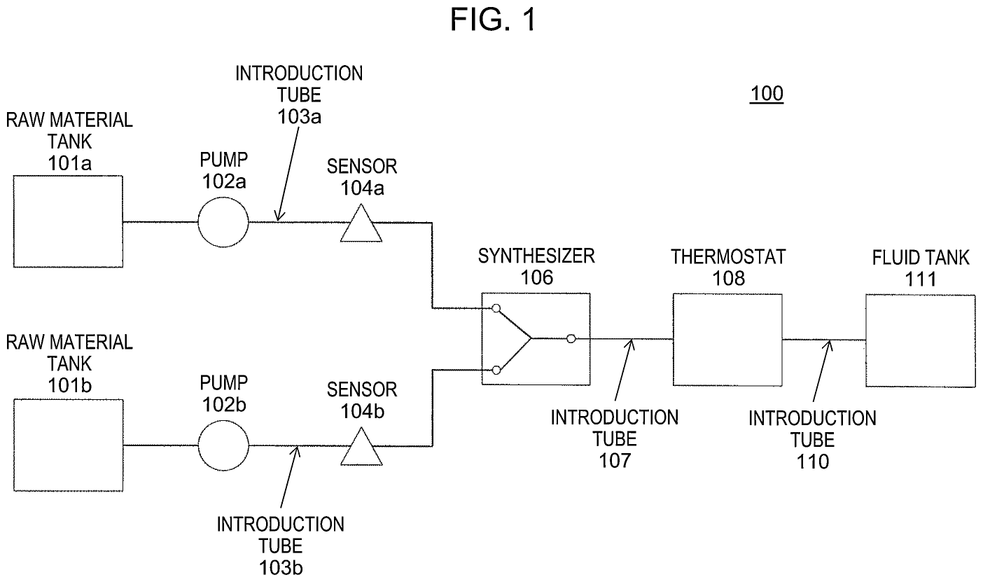

FIG. 1 is a schematic view illustrating a configuration of a synthesis device 100 according to the present exemplary embodiment. Synthesis device 100 includes raw material tanks 101a and 101b, synthesizer 106, thermostat 108, and a fluid tank 111.

### <Raw Material Tank>

The raw material fluid is stored in each of raw material tank 101a and raw material tank 101b. The raw material fluid stored in raw material tanks 101a and 101b is fed to synthesizer 106 through introduction tubes 103a and 103b by pumps 102a and 102b. Here, pumps 102a and 102b are preferably used as a syringe pump, a gear pump, a plunger pump, or the like depending on the purpose.

### <Synthesizer>

In synthesizer 106, the raw material fluids fed from raw material tank 101a and raw material tank 101b are mixed to obtain a fluid containing particles in which nuclei obtained by reaction have grown. The fluid containing the particles synthesized by synthesizer 106 is sent to thermostat 108 via introduction tube 107, and the growth of the particles is controlled. The fluid containing the produced particles is stored in fluid tank 111 through introduction tube 110.

Here, synthesizer 106 obtains a fluid containing particles generated by the reaction of the raw material fluid by continuously mixing and retaining the plurality of raw material fluids using a microfluidic device to be described later.

### <Thermostat>

Thermostat 108 completes the reaction while transferring the fluid into a tube having a length defined so that the reaction proceeds sufficiently. At this time, the temperature of synthesizer 106 and thermostat 108 may be appropriately adjusted.

The materials used for introduction tubes 103a, 103b, 107, and 110, synthesizer 106, and thermostat 108 may be appropriately changed according to the type of reaction as long as the materials do not adversely affect the reaction. For example, stainless steel, silicon, glass, Hastelloy, a silicon resin, or the like may be used, or the surface of these materials may be coated with a coating agent.

In addition, flowmeters are used as sensors 104a and 104b (also collectively referred to as a sensor 104), and the states inside the channels in introduction tubes 103a, 103b, 107, and 110, synthesizer 106, and thermostat 108 are detected and grasped. Here, a pressure sensor, an optical sensor, or the like may be used as the flowmeter for detecting the blockage. Not limited to introduction tubes 103a and 103b, sensors 104a and 104b may be installed also in introduction tubes 107 and 110 or thermostat 108. Here, since the raw material is fed at a constant liquid feeding speed, when no abnormality occurs in the channel, the flowmeters measured by sensors 104a and 104b show substantially constant values. On the other hand, when there is a blockage or a sign of blockage, the channel cross-sectional area decreases due to bonding and deposition of particles, so that the flow rates indicated by sensors 104a and 104b decrease. Therefore, when the values indicated by sensors 104a and 104b are less than a certain allowable range as compared with the steady value being set, it is possible to detect and grasp the blockage or the sign of the blockage.

### <Microfluidic Device>

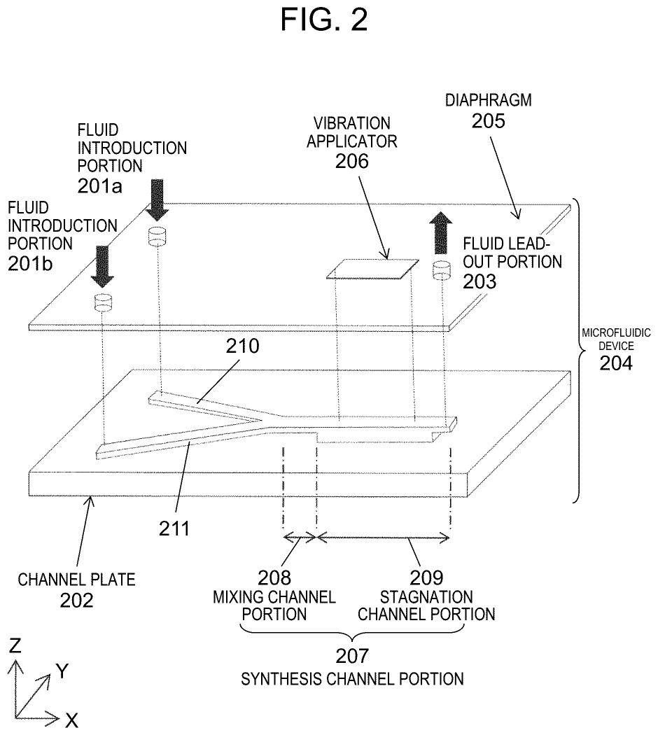

FIG. 2 is an exploded perspective view illustrating a configuration of a microfluidic device 204 according to the present exemplary embodiment used in synthesizer 106 of FIG. 1. For convenience, the flow direction of the fluid in synthesis channel portion 207 is defined as an X direction, the inside of the plane of microfluidic device 204 is defined as an XY plane, and a direction perpendicular to the X direction is defined as a Y direction. The vertically upward direction is defined as a Z direction.

Microfluidic device 204 includes first channel 210, second channel 211, synthesis channel portion 207, and vibration applicator 206. First channel 210 allows the first raw material fluid to flow, and second channel 211 allows the second raw material fluid to flow. Synthesis channel portion 207 joins first channel 210 and second channel 211 to cause the first raw material fluid and the second raw material fluid to react with each other to generate nuclei 301, thereby obtaining a fluid containing particles 302 obtained by growing nuclei 301. Vibration applicator 206 applies vibration to the fluid flowing through synthesis channel portion 207. Synthesis channel portion 207 includes mixing channel portion 208 and stagnation channel portion 209. Mixing channel portion 208 is a merging portion of first channel 210 and second channel 211. Stagnation channel portion 209 communicates with the downstream side of mixing channel portion 208, and vibration is applied to stagnation channel portion 209 by vibration applicator 206.

The raw material fluid fed from the raw material tank (not shown) via the introduction tube (not shown) is introduced into microfluidic device 204 via fluid introduction portions 201a and 201b. The first and second raw material fluids introduced from fluid introduction portions 201a and 201b are merged at mixing channel portion 208 formed in a concave shape in channel plate 202 via first and second channels 210 and 211 to generate nuclei 301. After mixing, the fluid containing particles 302 in which nuclei 301 have grown is led out of microfluidic device 204 from fluid lead-out portion 203 connected to introduction tube 107 (not illustrated) via stagnation channel portion 209 on the downstream side of mixing channel portion 208.

Each member included in microfluidic device 204 will be described below.

### <First and Second Channels>

First and second channels 210 and 211 only need to be formed in concave shapes in channel plate 202. It should be noted that channel plate 202 only needs to be self-standing and to be able to provide a concave channel. Channel plate 202 can be made of any commonly used material such as stainless steel, silicon, glass, Hastelloy, and a silicon resin.

### <Synthesis Channel Portion>

As described above, synthesis channel portion 207 includes mixing channel portion 208 on the upstream side in the fluid flowing direction (X direction) and stagnation channel portion 209 on the downstream side.

### <Mixing Channel Portion>

Mixing channel portion 208 is a merging portion of first and second channels 210 and 211. The first fluid flowing through first channel 210 and second fluid flowing through second channel 211 merge and react at mixing channel portion 208 to generate nuclei 301. In mixing channel portion 208, for example, a channel having a width in a range from 0.1 mm to 1.0 mm and a depth in a range from 0.1 mm to 1.0 mm may be formed.

Here, mixing channel portion 208 is not necessarily limited to a channel in which two types of solutions are mixed, and may hold a channel in which three or more types of solutions are mixed, or a channel in which these channels are multilayered. In FIG. 2, first and second channels 210 and 211 and mixing channel portion 208 are arranged in a Y shape, but the relationship of the three channels is not limited thereto.

### <Stagnation Channel Portion>

Stagnation channel portion 209 communicates with the downstream side of mixing channel portion 208. Stagnation channel portion 209 may be formed with a channel having a width in a range from 0.1 mm to 1.0 mm and a depth in a range from 0.1 mm to 2.0 mm.

Vibration is applied to an upper portion of stagnation channel portion 209 by vibration applicator 206 via diaphragm 205. This vibration makes it possible to prevent nuclei 301 and particles 302 from being bonded to and deposited on the wall surface of the channel.

### <Vibration Applicator>

As vibration applicator 206, for example, a piezoelectric element may be used. In addition, the vibration may be applied by ultrasonic irradiation. Furthermore, in order to obtain the effect of preventing bonding and deposition, for example, the thickness of diaphragm 205 is preferably small.

### <Cross-Sectional Structure of Synthesis Channel Portion>

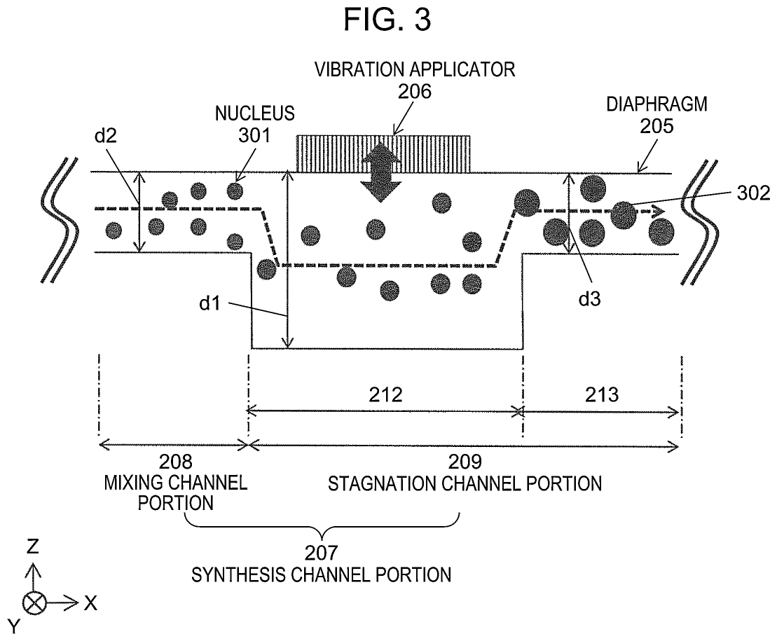

FIG. 3 is a partial cross-sectional view illustrating a cross-sectional structure of synthesis channel portion 207 of microfluidic device 204 according to the present exemplary embodiment.

As shown in FIG. 3, stagnation channel portion 209 has stagnation channel first portion 212 in which a fluid cross-sectional area (hereinafter also simply referred to as a fluid cross-sectional area) perpendicular to the fluid flowing direction (X direction) is larger than the fluid cross-sectional area of mixing channel portion 208. In addition, stagnation channel portion 209 may have stagnation channel second portion 213 that is on the downstream side of stagnation channel first portion 212 and has a fluid cross-sectional area smaller than that of stagnation channel first portion 212. For example, the length of stagnation channel first portion 212 along the vibration direction (−Z direction) applied from vibration applicator 206 may be longer than the length of mixing channel portion 208 along the vibration direction. Specifically, as shown in FIG. 3, in stagnation channel first portion 212, channel depth d1 in the vertical direction (−Z direction) may be partially larger than channel depth d2 of mixing channel portion 208 in the upstream portion. As a result, the vibration is received by vibration applicator 206 via diaphragm 205 from the vertically upper side (Z direction), so that it is possible to form a stable laminar flow state without being affected by vibration such as a reverse flow to the upstream portion including mixing channel portion 208.

Furthermore, as described above, in addition to the fact that channel depth d1 of stagnation channel portion 209 is larger than channel depth d2 of mixing channel portion 208, vibration applicator 206 is installed only in the central portion of stagnation channel portion 209 that does not straddle mixing channel portion 208, thereby forming a stable laminar flow state of mixing channel portion 208.

Here, by making channel depth d1 of at least a part (stagnation channel first portion) 212 of the stagnation channel portion larger than channel depth d2 of mixing channel portion 208 only toward the side where vibration applicator 206 is installed, it is possible to secure the channel depth of stagnation channel portion 209 without increasing the number of stagnation points. Furthermore, channel depth d3 of stagnation channel second portion 213 on the downstream side of at least a part (stagnation channel first portion) 212 of the stagnation channel portion may be smaller than channel depth d1 of at least a part (stagnation channel first portion) 212 of stagnation channel portion. By making channel depth d3 of stagnation channel second portion 213 shallower than channel depth d1, an effect of canceling the pressure wave transmitted to stagnation channel second portion 213 by vibration applicator 206 can be obtained. In addition, particles 302 coarsening in the path can be smoothly led out from fluid lead-out portion 203 connected to the introduction tube (not illustrated in FIG. 3) using the capillary phenomenon.

### EXAMPLE

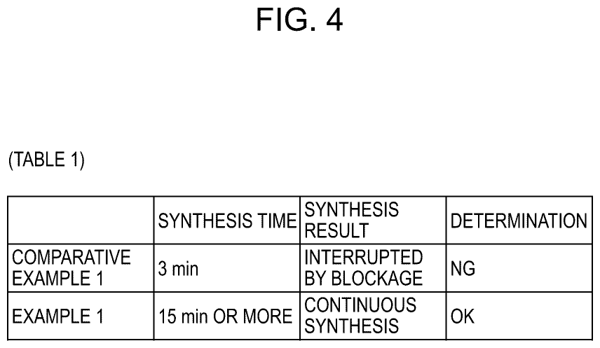

The experimental results will be described with reference to Table 1 in FIG. 4. Table 1 in FIG. 4 shows synthesis times, synthesis results, and determinations of Example 1 and Comparative Example 1.

A 0.1 mol/l silver nitrate aqueous solution is stored in raw material tank 101a. A 0.1 mol/l sodium chloride aqueous solution is stored in raw material tank 101b.

In synthesizer 106 of Example 1, microfluidic device 204 in which mixing channel portion 208 having a channel width of 0.25 mm and a channel depth of 0.25 mm, and stagnation channel portion 209 having a channel width of 0.25 mm and a channel depth of 0.5 mm were formed on channel plate 202, and vibration applicator 206 was installed above stagnation channel portion 209 via diaphragm 205 was used.

As synthesizer 106 of Comparative Example 1, a reactor was used in which mixing channel portion 208 having a channel width of 0.25 mm and a channel depth of 0.25 mm and stagnation channel portion 209 having a channel width of 0.25 mm and a channel depth of 0.25 mm were formed on channel plate 202.

Synthesizer 106 and thermostat 108 are installed in a thermostatic bath at 20° C. in both Example 1 and Comparative Example 1.

When the two liquids were respectively fed from raw material tanks 101a and 101b at 5 ml/min, the liquid feeding amount during the steady operation was 5 ml/min, and thus the allowable range of sensor 104 during the steady operation was set to a range from 4 ml/min to 6 ml/min.

As a result of the liquid feeding experiment, in Comparative Example 1, the liquid feeding amount was less than 4 ml/min after 3 minutes, and the operation was stopped. At this time, it was observed that nuclei 301 generated in stagnation channel portion 209 and grown particles 302 were bonded and deposited to block at a position 1 mm rearward from the outlet of mixing channel portion 208.

On the other hand, since synthesizer 106 of Example 1 applied vibration to the channel wall surface of stagnation channel portion 209 by ultrasonic irradiation while operating for 15 minutes, nuclei 301 and particles 302 bonded to and deposited on the channel wall surface were detached, whereby blockage was avoided. After 15 minutes of operation, the liquid feeding amount was still within the allowable range from 4 ml/min to 6 ml/min of sensor 104 during steady operation.

As described above, it has become clear that nuclei 301 and particles 302 bonded to and deposited on the wall surface of the channel can be detached by the effect of vibration application by ultrasonic irradiation, and can withstand synthesis for a long time.

According to the structure of Example 1, in synthesis for continuously generating particles by mixing a plurality of fluids in a channel, particularly even with a material whose time from nucleation to a growth phase in a particle formation process is short, it is possible to detach the nuclei and particles bonded to and deposited on the wall surface of the channel and to avoid blockage. Further, it is possible to simultaneously realize uniform mixing of a plurality of fluids in the mixing channel portion and to stably produce particles having a uniform particle diameter.

Furthermore, in the case of synthesis in which a plurality of fluids is mixed in a channel, not only particles can be continuously generated, but also blockage can be avoided by a similar effect even in a material system having a high thickening rate during synthesis. Further, it is possible to simultaneously realize uniform mixing of a plurality of fluids in the mixing channel portion and to stably produce a compound.

### INDUSTRIAL APPLICABILITY

The microfluidic device according to an aspect of the present disclosure can stably produce particles having a uniform particle diameter even with a material whose time from nucleation to a growth phase in a particle formation process is short. Therefore, the present invention can be applied to various applications other than the particle manufacturing process, such as a material system having a high thickening rate during synthesis.

### REFERENCE MARKS IN THE DRAWINGS

100 synthesis device
101a, 101b raw material tank
102a, 102b pump
103a, 103b, 107, 110 introduction tube
104, 104a, 104b sensor
106 synthesizer
108 thermostat
111 fluid tank
201a, 201b fluid introduction portion
202 channel plate
203 fluid lead-out portion
204 microfluidic device
205 diaphragm
206 vibration applicator
207 synthesis channel portion
208 mixing channel portion
209 stagnation channel portion
210 first channel
211 second channel
212 stagnation channel first portion
213 stagnation channel second portion
301 nuclei
302 particles

1. A microfluidic device comprising:
a first channel through which a first raw material fluid flows;
a second channel through which a second raw material fluid flows;
a synthesis channel portion that joins the first channel and the second channel to cause the first raw material fluid and the second raw material fluid to react with each other to generate nuclei, thereby obtaining a fluid containing particles obtained by growing the nuclei; and
a vibration applicator that applies vibration to the fluid flowing through the synthesis channel portion,
wherein the synthesis channel portion includes
a mixing channel portion that is a merging portion of the first channel and the second channel, and
a stagnation channel portion that communicates with a downstream side of the mixing channel portion and to which vibration is applied by the vibration applicator.

2. The microfluidic device according to claim 1, wherein a fluid cross-sectional area of at least a part of the stagnation channel portion perpendicular to a flow direction of the fluid is larger than a fluid cross-sectional area of the mixing channel portion perpendicular to the flow direction of the fluid.

3. The microfluidic device according to claim 2, wherein
the at least a part of the stagnation channel portion is a stagnation channel first portion on an upstream side, and
the stagnation channel portion further includes a stagnation channel second portion that is on a downstream side of the stagnation channel first portion and has a fluid cross-sectional area perpendicular to the flow direction of the fluid smaller than the fluid cross-sectional area perpendicular to the flow direction of the fluid in the stagnation channel first portion.

4. The microfluidic device according to claim 2, wherein a length of the at least a part of the stagnation channel portion along a vibration direction applied from the vibration applicator is longer than a length of the mixing channel portion along the vibration direction.

5. The microfluidic device according to claim 2, wherein
the vibration applicator applies vibration to the stagnation channel portion from above in a vertical direction, and
a channel depth of the at least a part of the stagnation channel portion in the vertical direction is greater than a channel depth of the mixing channel portion in the vertical direction.

6. A synthesis device comprising the microfluidic device according to claim 1 as a synthesizer.
